(19) United States
(12) Patent Application Publication
(10) Pub. No.: US 2025/0124215 A1
(43) Pub. Date: Apr. 17, 2025

(54) SUMMARIZATION PROCESSOR FOR UNSTRUCTURED HEALTH CARE DOCUMENTATION RECEIVED FROM OVER A COMMUNICATIONS NETWORK

(71) Applicant: Concord III, LLC, Seattle, WA (US)

(72) Inventors: Chris Larkin, Seattle, WA (US); Andre Sublett, Bainbridge Island, WA (US); Shawn Brockman, Seattle, WA (US)

(73) Assignee: Concord III, LLC, Seattle, WA (US)

(21) Appl. No.: 18/484,663

(22) Filed: Oct. 11, 2023

(51) Int. Cl. G06F 40/151; G06V 30/414

(52) U.S. Cl. CPC G06F 40/151; G06V 30/414

(57) ABSTRACT

Document summarization includes receiving an origin document. Document summarization additionally includes a segmentation of the text of the origin document into different text sections and the submission of the different text sections to a large language model (LLM) through a generative AI engine with a pre-cursor directive to prepare for each of the different text sections, a summarization so as to produce a set of summarizations. Document summarization yet further includes a follow-on submission of the summarizations to the LLM of the generative AI engine with the pre-cursor directive to prepare a summarization of the summarizations. Finally, document summarization includes an insertion of the summarization of the summarizations into a summarization document along with each individual summarization of the different text sections and the persistence of the summarization document in the memory.

### BACKGROUND OF THE INVENTION

### Field of the Invention

The present invention relates to the technical field of document processing and more particularly to the transformation of data within an origin document into a summarization document of the origin document.

### Description of the Related Art

Document processing is the technical field of receiving an electronic file, rendering the electronic file machine intelligible by converting the electronic file into processible data tokens, and performing computational directives upon the data tokens. In some instances, the electronic file is machine intelligible upon receipt stored in a format processible into the data tokens such as a schema-less flat file or a schema confirming structured file. But, in other instances, the electronic file is a mere raster image of content and the raster image first must be subjected to optical character recognition (OCR) in order to generate a machine intelligible collection of data tokens representative of the content in the raster image. A facsimile (fax) document is one such electronic file.

The fax document long has proven to be the workhorse of point to point communications, only to be overtaken by electronic messaging. Yet, the fax document has proven its resiliency in some cases by riding the technological coattails of electronic messaging in order to provide alternate digital channels for the delivery of fax transmissions. The resiliency of fax communications has allowed fax communications to remain the primary, reliable mode of information exchange for many industries, including health care, owing to the inherent way in which the document originator and document recipient can individually elect whether or not to work with hard copy documents, digital forms of the hard copy documents, or both.

In some instances, a fax transmission involves a document of limited content such that the content can be readily ascertained in summary, either manually with human supervision, or automatically through automated computer processing. However, in other instances, a fax transmission can include a document of substantially dense content, or substantial length. In the latter circumstance, it can be helpful to automatically construct a summary of the content of the document for viewing in a display of a recipient computing device. To the extent that the content of the fax transmission is structured according to a known schema, computing a summarization can be as simple as locating headings for different sections of the document and, just as a word processor generates a table of contents for a document, a summarization can be generated as the aggregation of the located headings.

It is to be understood, however, that many types of documents do not conform to a single, uniform schema. Further, for many types of documents, there may be no headings or the headings can be obscured within the document by other content. Even further, not all sections of a document denoted by a heading are relevant to an overarching summarization while some sections are of paramount relevance for summarization. Thus, it can be critical to conveying an accurate summarization of a document to recognize which sections are more relevant than other sections for the purpose of summarizing the document. Indeed, where the document relates to health care information, properly summarizing the document in a timely fashion surely will impact whether or not a patient receives the delivery of sufficient health care.

### BRIEF SUMMARY OF THE INVENTION

Embodiments of the present invention address technical deficiencies of the art in respect to automated document summarization of a document. To that end, embodiments of the present invention provide for a novel and non-obvious method for generative AI tuned document summarization of an unstructured document received from over a communications network, including health care fax documents. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a document summarization method includes the receipt of an origin document from over a communications network into memory of a host computing device and, to the extent that the origin document is a raster image of a document, the optical character recognition of text from the raster image of the document. The method additionally includes a segmentation of the text into different text sections and the submission of the different text sections to a large language model (LLM) accessed through a generative AI engine with a pre-cursor directive to prepare for each of the different text sections, a summarization so as to produce a set of summarizations. The method yet further includes a follow-on submission of the summarizations to the LLM of the generative AI engine with the pre-cursor directive to prepare a summarization of the summarizations. Finally, the method includes an insertion of the summarization of the summarizations into a summarization document along with each individual summarization of the different text sections and the persistence of the summarization document in the memory.

In one aspect of the embodiment, the method additionally includes transforming the text of the origin document into a structured document and submitting the structured document to the LLM of the generative AI engine with the pre-cursor directive. To that end, optionally, the structured document includes a set of fields and a corresponding value for each of the fields. Other aspects of the embodiment include:
the pre-cursor directive includes a word count limit.
the pre-cursor directive includes a spoken language preference for the summarization of the text.
different terms in the summarization document are replaced with reference codes drawn from an index for a contextual domain of the origin document.

In another embodiment of the invention, a data processing system is adapted for document summarization. The system includes a host computing platform of one or more computers, each with memory and one or processing units including one or more processing cores. The computers include network communications circuitry and supporting software logic sufficient to manage data communications over a computer communications network including receiving electronic messages and transmitting queries to remotely disposed computing applications. As such, the computers are coupled over the computer communications network to a remotely disposed generative AI engine providing access to an LLM.

Of import, the system includes a summarization module. The summarization module includes computer program instructions enabled while executing in the memory of at least one of the processing units of the host computing platform to perform document summarization. In this regard, document summarization includes receiving an image of an origin document from over the communications network into the memory of the host computing platform and optical character recognizing text of the origin document. Document summarization further includes segmenting the recognized text into different text sections. Document summarization yet further includes both submitting the different text sections to the LLM of the generative AI engine with a pre-cursor directive to prepare for each of the different text sections, a summarization so as to produce a set of summarizations, and subsequently further submitting the summarizations to the LLM of the generative AI engine with the pre-cursor directive to prepare a summarization of the summarizations. Finally, document summarization includes inserting the summarization of the summarizations into a summarization document along with each individual summarization of the different text sections and persisting the summarization document in the memory.

In this way, the technical deficiencies of the document summarization of a multi-section electronically transmitted fax are overcome owing to the smoothing of relevance of different section summarizations by generating a summary of the section summaries with the assistance of an LLM by way of the generative AI engine so as to produce each individual section summary and also the summary of summaries.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of document summarization;

FIG. 2 is a block diagram depicting a data processing system adapted to perform one of the aspects of the process of FIG. 1; and,

FIG. 3 is a flow chart illustrating one of the aspects of the process of FIG. 1.

### DETAILED DESCRIPTION OF THE INVENTION

Embodiments of the invention provide for document summarization. In accordance with an embodiment of the invention, an electronic document such as a fax document can be received electronically from over a computer communications network. The electronic document is converted into a corpus of processible data tokens, for instance through optical character recognition, and the data tokens are segmented by document section, for instance by identifying ones of the data tokens indicative of a heading owing to the formatting of the data tokens to differ from the surrounding tokens, or the presence of organizational symbols before ones of the tokens. The data tokens in each section are then separately submitted to an LLM through a generative AI engine with a prompt for summarization. Once all of the summarizations have been received from the AI engine, the aggregation of the summarizations are submitted to the LLM through the generative AI engine to produce a document summary. Finally, both the individual summaries and the document summary are persisted to fixed storage in a summarization document.

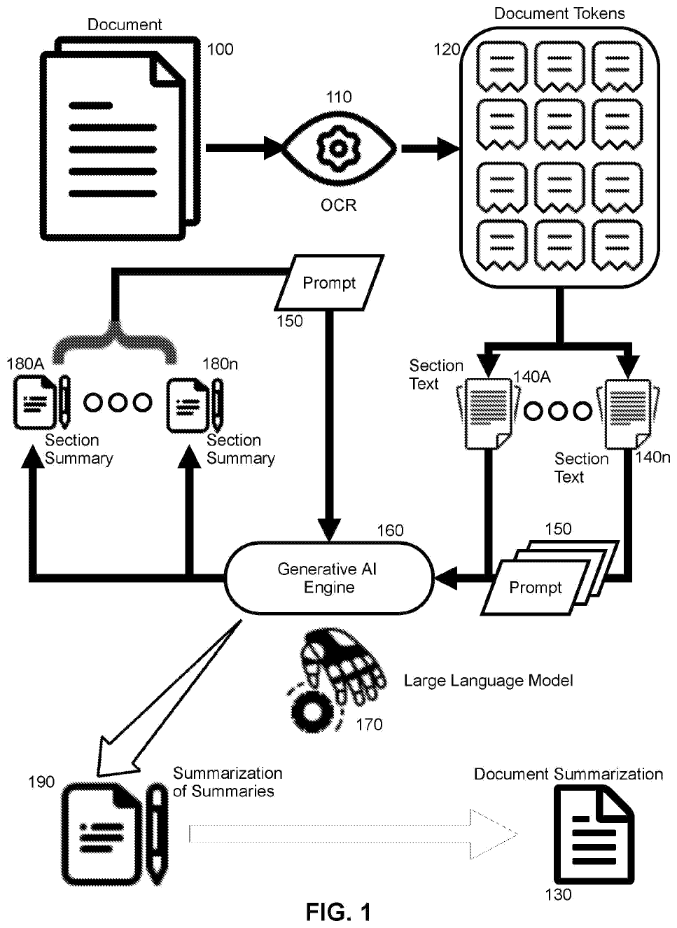

In illustration of one aspect of the embodiment, FIG. 1 pictorially shows a process of document summarization. As shown in FIG. 1, a document 100 is received and subjected to OCR 110 in order to produce a collection of document tokens 120, for instance different textual terms. The document terms 120 are organized into different sections of text 140A, 140n, for instance by locating amongst the document tokens 120, text associated with a section heading or section indicator and assigning a common section to the text following the section heading or section indicator. Thereafter, the section text 140A, 140n each is included in a summarization prompt 150 to a generative AI engine 160 accessing an LLM 170 to summarize the provided text.

For each of the prompts 150 for the section text 140A, 140n, a corresponding section summary 180A, 180n is produced by the generative AI engine 160. An aggregation of the section summaries 180A, 180n are then submitted in a summarization prompt 150 to the generative AI engine requesting a summarization of the section summaries 180A, 180n. The generative AI engine 160 returns in response to the summarization prompt 150 a summarization of summaries 190. The summarization of summaries 190 is then persisted in a summarization document 130 along with the individual section summaries 180A, 180n.

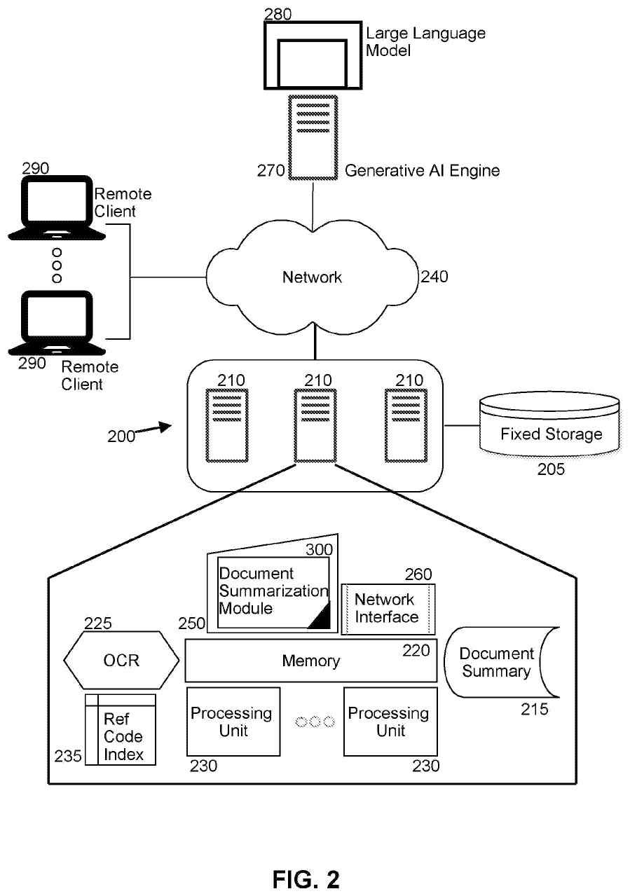

Aspects of the process described in connection with FIG. 1 can be implemented within a data processing system. In further illustration, FIG. 2 schematically shows a data processing system adapted to perform document summarization. In the data processing system illustrated in FIG. 1, a host computing platform 200 is provided. The host computing platform 200 includes one or more computers 210, each with memory 220 and one or more processing units 230 and accessing fixed storage 205.

The computers 210 of the host computing platform (only a single computer shown for the purpose of illustrative simplicity) can be co-located within one another and in communication with one another over a local area network, or over a data communications bus, or the computers can be remotely disposed from one another and in communication with one another through network interface 260 over a data communications network 240. The host computing platform 200 is communicatively coupled over the data communications network 240 to a generative AI engine 270 supported by an LLM 280. The host computing platform 200 further is communicatively coupled over the data communications network 240 to different remote clients 290.

Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for document summarization. Specifically, the program instructions during execution receive through the network interface 260 a document image of a document and the program instructions submit the document image to OCR 225 in order to produce into the memory 220 a corpus of textual tokens recognized within the document image.

Thereafter, the program instructions arrange the textual tokens into a structured form including a multiplicity of different sections. In one aspect of the embodiment, the structured form includes a set of fields and a corresponding value for each of the fields. In another aspect of the embodiment, the program instructions replace ones of the textual tokens with corresponding reference codes drawn from an index for a contextual domain of the document image in order to produce a uniform representation of different statements. The program instructions then generate a prompt for each corresponding one of the different sections seeking a summarization of the corresponding one of the different sections. Optionally, the program instructions include in each of the prompts a pre-cursor directive specifying, for example, a word count limit for a responsive summarization, or a spoken language preference for the responsive summarization.

Thereafter, the program instructions submit each of the prompts over the data communications network 240 to the generative AI engine 270 which responds with a section summarization for each of the different sections. Then, the program instructions aggregate the section summarization produced by the generative AI engine 270 for each of the different sections into a new prompt along with pre-cursor directive and the program instructions submit the new prompt to the generative AI engine 270 seeking a summarization of the aggregation of section summarizations. Finally, the program instructions store the resulting summary of summarizations into a document summary 215 in the memory 220 along with the section summarizations for each of the different sections and, to the extent available, the associated confidence values for each of the different sections.

Of note, a confidence value is produced for each of the section summarizations based upon an application of one or more confidence rules. In this regard, for each section summarization, the program instructions compute a score. The score varies according to a scoring table which assigns scores based upon a number of factors including:
Upon identifying a verified clinical synopsis amongst the textual tokens of the section, a corresponding synopsis is included in the section summarization;
Upon determining a threshold frequency of an appearance of a term amongst the textual tokens, the term also appears in the section summarization; Upon determining the present of test values amongst the textual tokens of the section, the same test values appear in the section summarization;

The scores determined for the different rules applied to the section summarization can be composited (for instance added together, averaged, or subjected to any computational algorithm) into a section summarization confidence value. To the extent that the confidence value for a particular section falls below a pre-determined threshold confidence, the process of section summarization can be repeated with a tuned prompt to the generative AI engine 270 with reference to one or more of the rules in order to provoke greater accuracy. The section summarization is then annotated with the confidence value so that when the section summarizations within the summary document are retrieved for viewing, the viewer can ascertain which section summarizations are of greatest likelihood to reflect the content of the underlying section summarized. As well, the confidence values for the section summarizations can be composited for the entire summary document and the summary document can be annotated with the composited confidence value so that the viewer can ascertain the likelihood that the summary document is a reflection of the underlying sections which had been summarized.

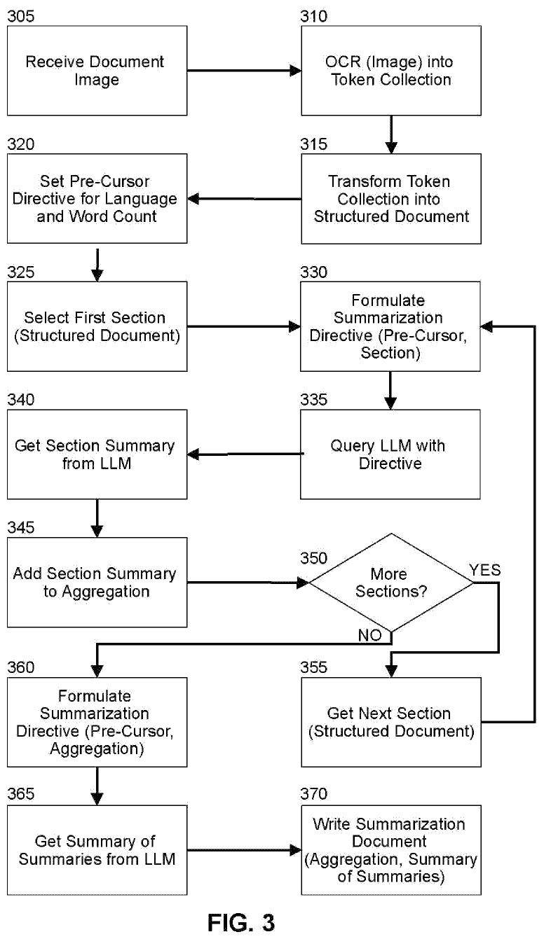

In further illustration of an exemplary operation of the module, FIG. 3 is a flow chart illustrating one of the aspects of the process of FIG. 1. Beginning in block 305, a document image is received from over a data communications network. In block 310, the document image is subjected to OCR to produce a corpus of textual tokens and in block 315, the textual tokens are organized into a structured document. In this regard, the tokens can be organized according to known sequence and position in the document and including display attributes such as italics, font size, font color, font boldness or font underline. Optionally, the tokens can be inserted into a templated structure or annotated according to a pre-defined schema including a set of fields and field values.

In block 320, a pre-cursor directive is established for a word count and a spoken language. Then, in block 325 a first section of the structured document is selected for processing. In block 330, a summarization prompt is formulated to include the pre-cursor directive and the first section and in block 335, the summarization prompt is transmitted through an application programming interface to the generative AI engine. Thereafter, in block 340 a section summarization is returned by the generative AI engine for the first section and in block 345, the section summarization is added to an aggregation. In decision block 350, it is determined if additional sections in the structured document remain to be processed. If so, in block 355 a next section in the document is selected and the process repeats through block 330.

In decision block 350, if it is determined that no further sections remain to be processed for the document, in block 360, a summarization prompt is generated including the pre-cursor directive and the aggregation of the section summaries. Then, in block 365 the summarization prompt upon submission to the generative AI engine results in the returns a summary of summaries from the generative AI engine. Finally, in block 370 a summarization document is persisted to storage including the summary of summaries and also each section summary.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A document summarization method comprising:
receiving an origin document from over a communications network into memory of a host computing device;
segmenting text of the origin document into different text sections;
submitting the different text sections over the communications network to a large language model (LLM) through a generative artificial intelligence (AI) engine with a pre-cursor directive to prepare for each of the different text sections, a summarization so as to produce a set of summarizations, and further submitting the summarizations to the LLM of the generative AI engine with the pre-cursor directive to prepare a summarization of the summarizations;
inserting the summarization of the summarizations into a summarization document along with each individual summarization of the different text sections; and,
persisting the summarization document in the memory.

2. The method of claim 1, wherein the electronic document is a raster image of a document, the method further comprising optical character recognizing the text from the origin document.

3. The method of claim 1, further comprising transforming the text of the origin document into a structured document and submitting the structured document to the LLM of the generative AI engine with the pre-cursor directive.

4. The method of claim 3, wherein the structured document comprises a set of fields and a corresponding value for each of the fields.

5. The method of claim 1, wherein the pre-cursor directive comprises a word count limit.

6. The method of claim 1, wherein the pre-cursor directive comprises a spoken language preference for the summarization of the text.

7. The method of claim 1, wherein different terms in the summarization document are replaced with reference codes drawn from an index for a contextual domain of the origin document.

8. A data processing system adapted for document summarization, the system comprising:
a host computing platform comprising one or more computers, each with memory and one or more processing units including one or more processing cores;
network communications circuitry and supporting software logic adapted to manage data communications over a computer communications network;
an optical character recognition engine; and,
a summarization module comprising computer program instructions enabled while executing in the memory of at least one of the processing units of the host computing platform to perform:
receiving an image of an origin document through the network circuitry from over the communications network into the memory of the host computing platform;
optical character recognizing text of the origin document in the optical character recognition engine;
segmenting the recognized text into different text sections;
submitting the different text sections through the network circuitry over the communications network to a large language model (LLM) through a generative artificial intelligence (AI) engine with a pre-cursor directive to prepare for each of the different text sections, a summarization so as to produce a set of summarizations, and further submitting the summarizations to the LLM of the generative AI engine with the pre-cursor directive to prepare a summarization of the summarizations;
inserting the summarization of the summarizations into a summarization document along with each individual summarization of the different text sections; and,
persisting the summarization document in the memory.

9. The system of claim 8, wherein the program instructions are further enabled to perform transforming the text of the origin document into a structured document and submitting the structured document to the LLM of the generative AI engine with the pre-cursor directive.

10. The system of claim 9, wherein the structured document comprises a set of fields and a corresponding value for each of the fields.

11. The system of claim 8, wherein the pre-cursor directive comprises a word count limit.

12. The system of claim 8, wherein the pre-cursor directive comprises a spoken language preference for the summarization of the text.

13. The system of claim 8, wherein different terms in the summarization document are replaced with reference codes drawn from an index for a contextual domain of the origin document.

14. A computing device comprising a non-transitory computer readable storage medium having program instructions stored therein, the instructions being executable by at least one processing core of a processing unit to cause the processing unit to perform document summarization comprising:
receiving an origin document from over a communications network into memory of a host computing device;
segmenting text of the origin document into different text sections;
submitting the different text sections over the communications network to a large language model (LLM) through a generative artificial intelligence (AI) engine with a pre-cursor directive to prepare for each of the different text sections, a summarization so as to produce a set of summarizations, and further submitting the summarizations to the LLM of the generative AI engine with the pre-cursor directive to prepare a summarization of the summarizations;
inserting the summarization of the summarizations into a summarization document along with each individual summarization of the different text sections; and,
persisting the summarization document in the memory.

15. The device of claim 14, wherein the electronic document is a raster image of a document, the method further comprising optical character recognizing the text from the origin document.

16. The device of claim 14, wherein the document summarization further includes transforming the text of the origin document into a structured document and submitting the structured document to the LLM of the generative AI engine with the pre-cursor directive.

17. The device of claim 16, wherein the structured document comprises a set of fields and a corresponding value for each of the fields.

16. The device of claim 14, wherein the pre-cursor directive comprises a word count limit.

17. The device of claim 14, wherein the pre-cursor directive comprises a spoken language preference for the summarization of the text.

20. The device of claim 14, wherein different terms in the summarization document are replaced with reference codes drawn from an index for a contextual domain of the origin document.
